(19) United States
(12) Patent Application Publication
(10) Pub. No.: US 2019/0330751 A1
(43) Pub. Date: Oct. 31, 2019

(54) SOEC System with Heating Ability

(71) Applicant: HALDOR TOPSØE A/S, Kgs. Lyngby (DK)

(72) Inventors: Bengt Peter Gustav Blennow, Malmö (SE); Thomas Heiredal-Clausen, Copenhagen Ø (DK); Tobias Holt Nørby, Glostrup (DK); Rainer Küngas, Copenhagen S (DK); Jeppe Rass-Hansen, København V (DK); Theis Løye Skafte, Hvidovre (DK)

(73) Assignee: HALDOR TOPSØE A/S, Kgs. Lyngby (DK)

(21) Appl. No.: 16/310,254

(22) PCT Filed: Jun. 8, 2017
(86) PCT No.: PCT/EP2017/063960

§ 371 Date: Dec. 14, 2018

(30) Foreign Application Priority Data
Jun. 17, 2016 (DK) PA 2016 00356

(51) Int. Cl. C25B 9/18; C25B 13/04; C25B 15/02; C04B 37/00

(52) U.S. Cl. CPC C25B 9/18; C25B 13/04; C25B 15/02; C04B 37/003; C04B 2237/708; C04B 2237/34; C04B 2237/068; C04B 2237/60; C04B 2237/348

(57) ABSTRACT

A Solid Oxide Electrolysis System has electrolytes with increased Area Specific Resistance, ASR yet is thin as compared to known electrolytes in the field, to obtain heating of the endothermic reducing process performed in the electrolysis cells directly where it is needed without any extra heating appliances or integrated heating elements, a simple efficient solution which does not increase the volume of the stack.

The present invention relates to a Solid Oxide Electrolysis Cell (SOEC) system with heating ability. Particular it relates to an SOEC system comprising SOEC cells which have a high area-specific resistance of electrolyte relative to the thickness of the electrolyte, which improves the efficiency of the SOEC system by reducing the necessary components for heating and minimizing the heat loss of the system from piping and external heater surfaces.

Solid Oxide Cells can be used for a wide range of purposes including both the generation of electricity from different fuels (fuel cell mode) and the generation of synthesis gas (CO+H2) from water and carbon dioxide (electrolysis cell mode).

Solid oxide cells are operating at temperatures in the range from 600° C. to above 1000° C. and heat sources are therefore needed to reach the operating temperatures when starting up the solid oxide cell systems e.g. from room temperature.

For this purpose, external heaters have been widely used. These external heaters are typically connected to the air input side of a solid oxide cell system and are used until the system has obtained a temperature above 600° C., where the solid oxide cells operation can start.

During the electrochemical operation of the solid oxide cell, heat is typically produced in relation to the Ohmic loss, given by

Q=R*I² (1)

where Q is the heat generated, expressed in Joules, R is the electrical resistance of the solid oxide cell (stack), measured in Ohms, and I is the operating current, measured in Amperes.

Furthermore, heat is produced or consumed by the electrochemical process as:

Q=−(ΔH*I*t)/(n*F) (2)

where ΔH is the chemical energy for a given ‘fuel’ (e.g. the lower heating value for a given fuel) at operating temperature, expressed in J/mol, t is time in seconds, n is the number of electrons produced or used in reaction per mole of reactant, and F is Faraday's number, 96 485 C/mol. By ‘fuel’ is here understood the relevant feedstock which can either be oxidised in fuel cell mode (e.g. H₂ or CO) or the products (again e.g. H₂ or CO) which other species (e.g. H₂O or CO₂) can be reduced into in electrolysis mode.

In equation (2), heat is generated in fuel cell mode (positive sign of the current) and heat is consumed in electrolysis mode (negative sign of the current).

When operating in galvanostatic mode, heat is produced in Solid Oxide Fuel Cell (SOFC) mode at all operating voltages. In SOEC mode, when the solid oxide cell is operated below the so-called thermoneutral voltage, the heat generated due to ohmic heating within the cell is less than the heat absorbed in the electrochemical reaction and the overall process is endothermic. Conversely, when a solid oxide cell in SOEC mode is operated above the thermoneutral voltage, the contribution from ohmic heating within the cell is larger than the heat absorbed in the electrochemical reaction and the overall process is exothermic.

Thermoneutral potential (voltage) is defined as the potential at which the electrochemical cell operates adiabatically, and is defined as

V_tn=−ΔH/(n*F).

In other words, V_tn is the minimum thermodynamic voltage at which a perfectly insulated electrolyzer would operate, if there were no net inflow or outflow of heat. For example, for water electrolysis performed at 25° C., V_tn is 1.48 V, but at 850° C., V_tn is 1.29 V. For CO₂ electrolysis, V_tn is 1.47 V at 25° C. and 1.46 V at 850° C. It is important to note that the real thermoneutral voltage of a real, imperfectly insulated stack will be different from the thermodynamically determined V_tn.

For SOFC in general and for SOEC systems operating above V_tn, no additional heating elements are in general needed to maintain the desired operating temperature of a solid oxide cell system.

However, for a system operating in SOEC mode with currents corresponding to voltages below V_tn, heat is consumed in the process and additional heat sources operating at temperatures close to or above the stack operating temperature are needed to maintain the necessary operating temperature.

The temperature profile across a stack during operation is not constant. Due to the exothermic nature of the fuel combustion reaction, the side of the stack where fuel inlets are located is generally colder than the side of the stack where fuel outlets are located. Conversely, a stack operating in electrolysis mode below thermoneutral voltage will generally be hotter on the side with fuel inlets compared to the side with fuel outlets. The magnitude of the temperature gradient across the stack depends on stack geometry, flow configuration (co-, cross-, counterflow, etc.), gas flow rates, current density, etc. For example, when operating in fuel cell mode, large flow of (relatively cool) air is typically needed to cool the stack and decrease the temperature gradient from inlet to outlet, whereas in electrolysis mode below V_tn, a large flow of hot air can be used to heat the stack. However, heating or cooling the stack by using high gas flow rates is an expensive way of controlling stack temperature, as large blowers and heaters are needed that reduce the efficiency of the entire system considerably.

Generally, it is common to use the same or only slightly modified cells and stacks for fuel cell and electrolysis operation. For example, EP1984972B1 describes a heat and electricity storage system comprising a reversible fuel cell having a first electrode and a second electrode separated by an ionically conducting electrolyte. Such a cell would produce chemicals, such as hydrogen and oxygen, in electrolysis mode, and could also be operated on the produced fuel in fuel cell mode. The disadvantage with a system where the same cells or the same stack is used for both fuel cell and electrolysis operation is that a cell having optimal performance in fuel cell mode will, as will be shown below, not necessarily perform optimally in electrolysis mode.

In addition to a temperature gradient, concentration gradients of reacting and forming species also exist in an operating solid oxide cell stack. For example, an electrolysis stack operating in steam electrolysis mode (i.e. converting H₂O into H₂) will have high concentrations of steam near fuel inlets, and low concentrations of steam near fuel outlets. The concentration of the formed hydrogen gas will vary accordingly from low to high from inlet to outlet. Similar to a chemical reactor, it is desirable to convert as much of the starting material into desirable product as possible as the chemicals flow through the stack, i.e. to achieve highest possible conversion per pass. Higher conversion means that less of the gas needs to be recycled, or alternatively, that the gas purification system downstream of the cell or stack can be operated more efficiently—both of which reduce costs. However, the higher the conversion, the larger the concentration gradients from fuel inlet to outlet.

In a cell or stack operating in CO₂ electrolysis mode (converting CO₂ into CO) or in co-electrolysis mode (converting CO₂ and H₂O simultaneously into CO and H₂), fuel inlets are subjected to a relatively high concentration of CO₂, while fuel outlets are rich in carbon monoxide, CO. High-conversion operation is complicated by the Boudouard reaction

2CO=CO₂+C,

which can lead to carbon formation in the cell, if the concentration of CO becomes too high. Carbon formation within cells is highly undesirable, as it leads to the blocking of the pores within the cell, destruction of the Ni-rich electrode structure, and possibly, to delaminations between electrolyte and the reducing electrode. All of these phenomena can lead to the failure of an electrolysis stack, thus carbon formation needs to be avoided. Furthermore, once occurred, damage from carbon formation seems to be irreversible, therefore the prevention of carbon formation is critical for achieving long cell and stack lifetimes.

The likelihood of carbon formation via Boudouard reaction is governed by thermodynamics. Essentially, carbon formation becomes the more probable, the higher the CO/CO₂ ratio, the higher the absolute pressure, and the lower the operating temperature. For example, at 1 atm, the equilibrium molar ratio of CO/CO₂ (above which carbon formation is thermodynamically favored and below which it is thermodynamically un-favored) is 89:11 at 800° C., 63:37 at 700° C., and 28:72 at 600° C. In other words, Boudouard reaction can severely limit the maximum conversion that can be achieved in an electrolysis stack operating with a fuel inlet temperature of 750° C. or below. When such a stack is operated below thermoneutral voltage, the endothermic CO₂ reduction reaction cools the stack further, leading to even lower local temperatures in the middle of the stack and near fuel outlets.

The common understanding within the field is that a solid oxide cell should have as low area-specific resistance (ASR) as possible. Therefore, all fuel cell and fuel cell stack manufacturers strive towards decreasing the ASR of the cells and of the stack.

However, according to search results forming some of the basis for the present invention, the issue of cell ASR is more complex. Because electrolysis is an endothermic process, the electrodes that are carrying out the reactions act as powerful heat sinks. There are several ways to provide heat for this process—e.g. using a furnace, by heating the gases before they reach the stack, and, importantly, by ohmic heating—by the heat generated as the current passes through the cell and stack components. The magnitude of ohmic heating in the cell is directly proportional to the electrical resistance of the electrolyte in the cell—the higher the resistance, the more heat is generated.

Surprisingly and unexpectedly, we have discovered that a cell with a high electrolyte resistance will be especially beneficial when operating the cell (or stack) in CO₂ electrolysis, as the risk of Boudouard carbon formation is lower at high temperatures. Providing the heat right there where it is needed without subjecting the stack globally to higher temperatures will help to increase stack lifetime. Yet at the same time, it is still relevant to reduce the ASR of all other cell components: the resistance related to the electrochemical processes, as well as the ohmic in-plane resistance of both the air- and the fuel-side cell layers.

There are several ways to increase the resistance of the electrolyte (make it thicker, reduce the Y₂O₃ content in YSZ (yttria-stabilized zirconia), etc.), but some ways are better and easier than others. We have found that increasing the sintering temperature of the bi-layer YSZ-doped ceria electrolyte is the easiest way to increase ASR. Recent stack tests and modelling results show that this has resulted in improved temperature current distributions within the stack in electrolysis.

Ohmic resistance of a single-phase electrolyte layer generally increases linearly with the thickness of said layer, thus increasing the layer thickness is a way to increase the ASR of the electrolyte. However, in cells where the mechanical strength of the cell does not come from the electrolyte, i.e. cathode- or anode-supported cells, increasing electrolyte thickness results typically in increased camber (bending) of the cell. The camber is the result of the build-up of internal stresses due to the difference in thermal expansion coefficients between the cathode and the electrolyte in cathode-supported cells or the anode and the electrolyte in anode-supported cells. The thicker the electrolyte, the larger the stresses and the more severe the camber. The advantage of the current invention compared to a cell with increased electrolyte thickness is that high ASR can be achieved without increasing electrolyte thickness, thus without increased camber.

The ionic conductivities of some of the more commonly used electrolyte materials can be found in the literature. For example, the oxygen ion conductivity of 8YSZ (8 mol % Y₂O₃-stabilised ZrO₂) as a function of temperature is given as

log σ=−4.418*(1000/T)+2.805,700K≤T≤1200K

(V. V. Kharton et al., Solid State Ionics, 174 (2004) 135). Thus, the area-specific resistance of a 25-μm 8YSZ electrolyte is 0.14 Ω cm² at 700° C. in air. The oxygen ion conductivity of 10ScSZ (10 mol % Sc₂O₃-stabilised ZrO₂) as a function of temperature is given as

log σ=−6.183*(1000/T)+3.365,573K≤T≤773K

(J. H. Joo et al., Solid State Ionics, 179 (2008) 1209). Thus, the area-specific resistance of a 25-μm 10ScSZ electrolyte is 0.03 Ω cm² at 700° C. in air.

The oxygen ion conductivity of CGO10 (10 mol % Gd₂O₃-doped CeO₂) as a function of temperature is given as

log σ=−2.747*(1000/T)+1.561,673K≤T≤973K

(A. Atkinson et al., Journal of The Electrochemical Society, 151 (2004) E186). Thus, the area-specific resistance of a 25-μm CGO10 electrolyte is 0.05 Ω cm² at 700° C. in air.

Based on the above, it is apparent that achieving an electrolyte ASR of 0.20 Ω cm² at 700° C. or higher is impossible in a 25-micron thick layer, when pure 8YSZ, 10ScSZ or CGO10, or a combination of the above are used as electrolyte.

However, when a combination of a zirconia-based electrolyte material, such as YSZ or ScSZ, is allowed to be in intimate contact with a ceria-based electrolyte material, such as CGO, at a high enough temperature for a long-enough time, the materials begin to interdiffuse and form a solid solution with significantly lower oxygen ion conductivity. For example, V. Rührup et al. (Z. Naturforsch. 61b, 916-922 (2006)) provides the temperature dependence of the ionic conductivity of a wide range of possible YSZ-CGO solid solutions, i.e. (Ce₁₋ₓZrₓ)_{0.8}Gd_{0.2}O_{1.9}, where 0≤x≤0.9. The ionic conductivity of these solid solutions is generally considerably lower than the conductivity of the pure phases. Unfortunately, the paper only provides ionic conductivity data up to 600° C. However, since the log (σ*T) vs 1/T data follow an excellent linear trend, the data can be extrapolated to 700° C. According to the extrapolated values, the ionic conductivity of (Ce_{0.5}Zr_{0.5})_{0.8}Gd_{0.2}O_{1.9} is 0.0011 S/cm at 700° C., i.e. more than a factor of 16 lower than that of pure 8YSZ and almost a factor of 50 lower than that of pure CGO10. Thus, the ASR of a 25-micron electrolyte made of pure (Ce_{0.5}Zr_{0.5})_{0.8}Gd_{0.2}O_{1.9} is estimated to be 2.27 Ω cm². A 400 nm layer made of this material would have an ASR of 0.036 Ω cm² at 700° C.

US2015368818 describes an integrated heater for a Solid Oxide Electrolysis System integrated directly in the SOEC stack. It can operate and heat the stack independently of the electrolysis process.

US20100200422 describes an electrolyser including a stack of a plurality of elementary electrolysis cells, each cell including a cathode, an anode, and an electrolyte provided between the cathode and the anode. An interconnection plate is interposed between each anode of an elementary cell and a cathode of a following elementary cell, the interconnection plate being in electric contact with the anode and the cathode. A pneumatic fluid is to be brought into contact with the cathodes, and the electrolyser further includes a mechanism ensuring circulation of the pneumatic fluid in the electrolyser for heating it up before contacting the same with the cathodes. Hence, US20100200422 describes the situation where heat has to be removed from the SOEC stack, whereas this invention relates to the opposite situation. It describes an invention where the heat exchanger (cooling) function is embedded between the cells. US20100200422 relates to additional heater blocks placed outside the stack but within the stack mechanics to reduce the hot area of the stack and heaters.

EP1602141 relates to a high-temperature fuel cell system that is modularly built, wherein the additional components are advantageously and directly arranged in the high-temperature fuel cell stack. The geometry of the components is matched to the stack. Additional pipe-working is thereby no longer necessary, the style of construction method is very compact and the direct connection of the components to the stack additionally leads to more efficient use of heat. However, EP1602141 is not in the technical field of SOEC and the particular problems related to SOEC. Especially the need for continuous and active heating of the cell stack during operation with a heating unit which is process independent of the SOEC and which operates at temperatures close to or above the stack operating temperature is not disclosed.

US2002098401 describes the direct electrochemical oxidation of hydrocarbons in solid oxide fuel cells, to generate greater power densities at lower temperatures without carbon deposition. The performance obtained is comparable to that of fuel cells used for hydrogen, and is achieved by using novel anode composites at low operating temperatures. Such solid oxide fuel cells, regardless of fuel source or operation, can be configured advantageously using the structural geometries of US2002098401. A series-connected design or configuration of US2002098401 can include electrodes that have sufficiently low sheet resistance Rₛ to transport current across each cell without significant loss. A target area-specific resistance (ASR) contribution from an electrode, <0.05 Ocm², is obtained by requiring that each electrode ohmic loss be <^{˜}10 percent of the stack resistance, and assuming a 0.5 Ocm² cell ASR (electrolyte ohmic loss and electrode polarization resistances). Using a standard expression for electrode resistance, ASR=RₛL²/2, where L is the electrode width of 0.1 cm, Rₛ<^{˜}10 O/square is obtained. Given the above numbers, the maximum power density for the array would be ^{˜}0.5 W/cm², calculated based on the active cell area. Note that increasing L to 0.2 cm decreases the desired Rₛ to <^{˜}2.5 O/square.

Despite the known art solutions described in the references above, there is a need for a more energy-efficient and economic heating system for an SOEC system. This problem is solved by the present invention according to the embodiments of the claims.

According to an embodiment of the invention, the solid oxide electrolysis system comprises a planar solid oxide electrolysis cell stack as known in the art from fuel cells and electrolysis cells. The stack comprises a plurality of solid oxide electrolysis cells and each cell comprises layers of: an oxidizing electrode, a reducing electrode and an electrolyte. The electrolyte comprises a first electrolyte layer, a second electrolyte layer, and a layer formed by interdiffusion of the first electrolyte layer and the second electrolyte layer. The electrolyte is adapted for electrolyse mode, in particular electrolyse of CO2 for the production of CO in that the area-specific resistance of the electrolyte, measured at 700° C., is higher than 0.2 Ω cm² and the total thickness of the electrolyte is less than 25 μm. I.e. a high resistance but at the same time a thin electrolyte relative to well-known electrolytes in the field. More particularly, the thickness of the electrolyte may be between 5 μm and 25 μm and preferably between 10 μm and 20 μm to have an optimal performance with regard to strength, total volume of the cell stack and ohmic resistance.

In a further embodiment of the invention, the first layer of the electrolyte is composed primarily of stabilized zirconia. Zirconia is a ceramic in which the crystal structure of zirconium dioxide is made stable at a wider range of temperatures by an addition of yttrium oxide. These oxides are commonly called “zirconia” (ZrO₂) and “yttria” (Y₂O₃). The second layer of the electrolyte is composed primarily of doped ceria (e.g. gadolia doped ceria) and the third layer between the first and the second layer is an interdiffusion layer, formed by interdiffusion of the first and the second layer.

In an embodiment of the invention, the interdiffusion layer is at least 300 nm. Further, in an embodiment of the invention, at least 65% of the area-specific resistance of the electrolyte in total comes from the interdiffusion layer.

In yet another embodiment of the invention, the interdiffusion layer is made by sintering the electrolyte layers at temperatures above 1250° C., preferably below 1350° C. Sintering the layers is done by compacting and forming a solid mass of material by heat and pressure without melting it to the point of liquefaction.

In a further embodiment of the invention, the oxidizing electrode has an in-plane electrical conductivity higher than 30 S/cm, preferably higher than 50 S/cm, when measured at 700° C. in air. In an embodiment, the oxidizing electrode comprises two or more layers.

In yet a further embodiment of the invention, the operating temperature of the solid oxide electrolysis system is in the range of 650° C. to 900° C. and the reaction occurring in the reducing electrode comprises the electrochemical reduction of CO₂ to CO.

### EXAMPLE 1 (COMPARATIVE EXAMPLE)

The example shows the performance of a planar solid oxide electrolysis cell stack, comprising 75 cells and 76 metallic interconnect plates. The cells comprised an LSCF/CGO based first oxidizing electrode, an LSM-based second oxidizing electrode, a Ni/YSZ reducing electrode, a Ni/YSZ support and an electrolyte, comprising of 8YSZ first electrolyte layer, a CGO second electrolyte layer, and a layer formed by interdiffusion of the first electrolyte layer and the second electrolyte layer. The thickness of the 8YSZ electrolyte layer was approximately 10 microns, and the thickness of the CGO electrolyte layer was approximately 4 microns. The sintering temperature of the bi-layer electrolyte was 1250° C., which, based on scanning electron microscopy investigations, results in an interdiffusion layer that is approximately 300 nm in thickness. The cells were 12 cm by 12 cm in size. The interconnect plates were made of Crofer22 stainless steel.

The cells used in the stack were tested in a single-cell test setup in fuel cell mode in a furnace with air fed to the cathode and humidified H₂ to the anode. The total ASR of such cells at a constant current density of 0.3125 A/cm² was estimated to be 0.372 Ω cm² at 750° C. and 0.438 Ω cm² at 720° C.

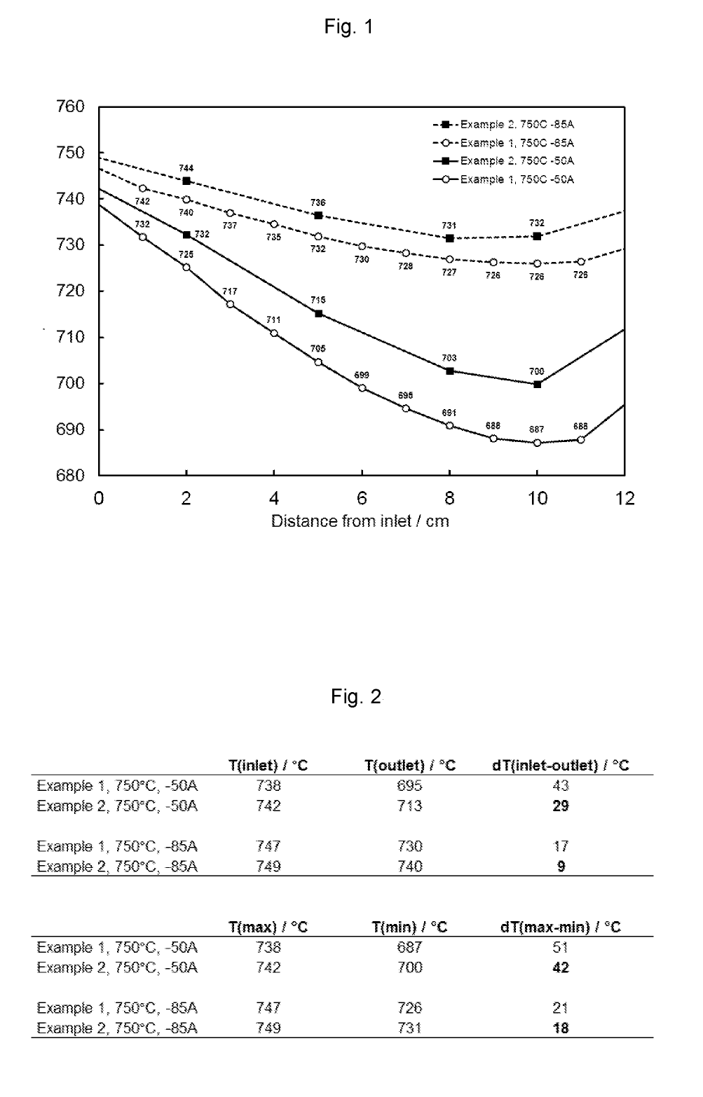

The stack described above was tested in CO₂ electrolysis mode with air fed to the air-side of the cells and a 5% H₂ in CO₂ mixture fed to the fuel-side of the cells. The stack was operated in a furnace held at a constant temperature of 750° C. in co-flow mode. The electrolysis current was varied from 0 to −85 A. The resulting temperature profiles were recorded using internal thermocouples placed along the flow direction from the inlet of the stack (‘0 cm’) to the outlet of the stack (‘12 cm’). Stack internal temperature profiles corresponding to electrolysis current values of −50 A and −85 A are shown in FIG. 1. Inlet, outlet, maximum, and minimum temperatures, as well as relevant temperature differences, are summarized in FIG. 2.

### EXAMPLE 2

The example shows the performance of another planar solid oxide electrolysis cell stack, similarly comprising 75 cells and 76 metallic interconnect plates. The cells were otherwise identical to cells in Example 1, except that the sintering temperature of the bi-layer electrolyte was 1300° C., which, based on scanning electron microscopy investigations, results in an interdiffusion layer that is approximately 360 nm in thickness. The interconnect plates were identical to these in Example 1.

The cells used in the stack were tested in a single-cell test setup in fuel cell mode in a furnace with air fed to the cathode and humidified H₂ to the anode. The total ASR of such cells at a constant current density of 0.3125 A/cm² was estimated to be 0.446 Ω cm² at 750° C. and 0.515 Ω cm² at 720° C.

The stack was tested under identical conditions to Example 1. The resulting temperature profiles were recorded using internal thermocouples placed along the flow direction from the inlet of the stack (‘0 cm’) to the outlet of the stack (‘12 cm’). Stack internal temperature profiles corresponding to electrolysis current values of −50 A and −85 A are shown in FIG. 1. Inlet, outlet, maximum, and minimum temperatures, as well as relevant temperature differences, are summarized in FIG. 2.

The inlet-to-outlet temperature difference, as well as the maximum-to-minimum temperature difference is lower in Example 2 than in Example 1 at both −50 A as well as at −85 A. This improvement is due to the higher electrolyte ASR, and thus higher heating ability of the cells used in Example 2 compared to Example 1.

1. A solid oxide electrolysis system comprising a planar solid oxide electrolysis cell stack comprising a plurality of solid oxide electrolysis cells, each cell comprising layers of an oxidizing electrode, a reducing electrode and an electrolyte, comprising of a first electrolyte layer, a second electrolyte layer, and a layer formed by interdiffusion of the first electrolyte layer and the second electrolyte layer, wherein the area-specific resistance of the electrolyte, measured at 700° C., is higher than 0.2 Ω cm² and the total thickness of the electrolyte is less than 25 μm.

2. A solid oxide electrolysis system according to claim 1, wherein the total thickness of the electrolyte is between 5 μm and 25 μm.

3. A solid oxide electrolysis system according to claim 1, wherein the first electrolyte layer is composed primarily of stabilized zirconia, the second electrolyte layer is composed primarily of doped ceria, and a third layer between the above layers is formed by interdiffusion (interdiffusion layer).

4. A solid oxide electrolysis system according to claim 3, wherein the first electrolyte material is primarily (Y₂O₃)ₓ(ZrO₂)₁₋ₓ, where 0.02≤x≤0.10 or (Y₂O₃)_{y}(L₂O₃)_{z}(ZrO₂)_{1-y-z} or (Sc₂O₃)_{y}(L₂O₃)_{z}(ZrO₂)_{1-y-z}, where 0.0≤y≤0.12, 0≤z≤0.06, and L is Ce, Gd, Ga, Y, Al, Yb, Bi, or Mn.

5. A solid oxide electrolysis systems according to claim 3, wherein the second electrolyte materials is primarily (Ln₂O₃)ₓ(CeO₂)₁₋ₓ, where 0.02≤x≤0.30, and Ln is a lanthanide or mixture of two lanthanides.

6. A solid oxide electrolysis system according to claim 1, wherein the thickness of the interdiffusion layer is at least 300 nm.

7. A solid oxide electrolysis system according to claim 1, wherein at least 65% of the area-specific resistance of the electrolyte originates from the interdiffusion layer.

8. A solid oxide electrolysis system according to claim 4, wherein the interdiffusion layer is obtained by sintering the electrolyte layers at temperatures above 1250° C.

9. A solid oxide electrolysis system according to claim 1, wherein the in-plane electrical conductivity of the oxidizing electrode, measured at 700° C. in air, at is higher than 30 S/cm.

10. A solid oxide electrolysis system according to claim 1, wherein the oxidizing electrode comprises two or more layers.

11. A solid oxide electrolysis system according to claim 10, wherein the oxidizing electrode layer closest to the electrolyte is a composite of doped ceria and Ln₁₋ₓ₋ₐSrₓMO_{3±δ}, where Ln is a lanthanide or mixture thereof, M is Mn, Co, Fe, Cr, Ni, Ti, Cu or mixture thereof, 0≤x≤0.95, 0≤a≤0.05, and 0≤δ≤0.25, and the oxidizing electrode layer farthest from the electrolyte is primarily Ln₁₋ₓ₋ₐSrₓMO_{3±δ}, Ln₁₋ₐNi_{1-y}Co_{y}O_{3±δ}, or Ln₁₋ₐNi_{1-y}Fe_{y}O_{3±δ}, where 0≤y≤1, or mixtures thereof.

12. A solid oxide electrolysis system according to claim 1 wherein the operating temperature is in the range of 650° C.-900° C.

13. A solid oxide electrolysis system according to claim 1 where the reaction occurring in the reducing electrode comprises the electrochemical reduction of CO₂ to CO.
